(19) United States
(12) Patent Application Publication
(10) Pub. No.: US 2026/0079528 A1
(43) Pub. Date: Mar. 19, 2026

(54) DIGITAL DISPLAY DEVICE AND METHOD FOR INTANGIBLE CULTURAL HERITAGE PRODUCTS

(71) Applicant: Chengdu University of Technology, Chengdu (CN)

(72) Inventors: Nan LYU, Chengdu (CN); Xinyu JIANG, Chengdu (CN)

(73) Assignee: Chengdu University of Technology, Chengdu, SC (CN)

(21) Appl. No.: 19/399,596

(22) Filed: Nov. 24, 2025

(30) Foreign Application Priority Data
Aug. 29, 2025 (CN) 202511226115.7

(51) Int. Cl. G06F 1/16; G06F 3/041; G06T 17/10

(52) U.S. Cl. CPC G06F 1/1601; G06F 3/0412; G06T 17/10

(57) ABSTRACT

The present disclosure discloses a digital display device and method for intangible cultural heritage products. The device comprises an exhibition cabinet with a transparent glass display function and an exhibition cabinet with a touch display function. The exhibition cabinet comprises a transparent display box in the upper part and a non-transparent equipment box in the lower part. A transparent display box is provided with a transparent placement platform for placing product models made by intangible cultural heritage techniques. The transparent placement platform is connected to the equipment box through a lifting and rotating switching component. A three-dimensional graphics acquisition and sensing component is arranged around the transparent placement platform. Three-dimensional models are generated and displayed on the touch display screen of the display cabinet, allowing people to observe the models in three dimensions and to explain and display them in conjunction with intangible cultural heritage techniques videos.

### TECHNICAL FIELD

The present disclosure relates to the field of display technology for intangible cultural heritage products, specifically to a digital display device and method for intangible cultural heritage products.

### BACKGROUND

Intangible Cultural Heritage, referred to as “non-heritage culture”, often conceptualized in contrast to “material cultural heritage”, constitutes one of the most dynamic and vital components of cultural diversity. As a crystallization of human civilization, intangible cultural heritage represents a precious common wealth that embodies human wisdom, reflects the splendor of historical civilizations, and serves as a manifestation of global cultural diversity.

Longquan celadon traditional firing techniques, Chinese traditional timber building construction techniques and other intangible cultural heritage products, can be integrated with the firing of ceramics, and the construction of wood structure models, thereby facilitating the display and promotion of intangible heritage. Conventionally, such demonstrations rely on placing artifacts crafted through intangible cultural heritage techniques into traditional exhibition cabinets, supplemented by textual descriptions and guided explanations. However, this kind of display fails to organically combine the holistic process of Intangible Cultural Heritage techniques with their resulting product models, resulting in overly monotonous exhibition formats. At the same time, the display cabinet has a single function and cannot meet the needs of an intelligent display.

### SUMMARY

The purpose of this present disclosure is to provide a digital display device and method for intangible cultural heritage products. Through a display cabinet with rotation and lifting functions, along with a three-dimensional graphics acquisition sensing component, the three-dimensional information of the models made by different intangible cultural heritage techniques is collected and transmitted to an upper computer. The upper computer generates three-dimensional graphics and displays them on a touch display screen of the display cabinet, which is convenient for people to observe the model made by intangible cultural heritage techniques in a three-dimensional way, and cooperate with a video explanation and display of intangible cultural heritage techniques, so that people can have a comprehensive understanding and awareness of intangible cultural heritage products.

In order to achieve the above purpose, the present disclosure provides a digital display device for intangible cultural heritage products, including an exhibition cabinet with a transparent glass display function and a display cabinet with a touch display function, a side of the exhibition cabinet is connected to a side of the display cabinet, the exhibition cabinet includes a transparent display box in an upper part and a non-transparent equipment box in a lower part, the transparent display box is provided with a transparent placement platform for placing product models made by intangible cultural heritage techniques, the transparent placement platform is connected to the equipment box through a lifting and rotating switching component, a top, a bottom and the side of the transparent placement platform are all provided with three-dimensional graphics acquisition and sensing components for collecting three-dimensional information, a touch display screen with height adjustment and pitch angle adjustment functions is provided with the display cabinet.

In some embodiments, the side of the transparent display box away from the display cabinet is provided with transparent glass with an opening and closing function, a top of the transparent display box, a front side, and a rear side of one side of the transparent display box vertically connected to the side away from the display cabinet are provided with transparent glass.

In some embodiments, the lifting and rotating switching component includes a composite drive disc, both sides of the composite drive disc are provided with a lifting structure, and a switching structure is arranged between the composite drive disc and the lifting structure.

In some embodiments, the composite drive disc includes a fixed disc arranged at a center, a side of the fixed disc is connected to a gear disc through a bearing, an outer side of the gear disc is provided with several transmission teeth, and a three-dimensional graphics acquisition and sensing component under the transparent placement platform is arranged on the fixed disc.

In some embodiments, a top of the gear disc is connected to the bottom of the transparent placement platform through several fixed columns; several guide columns are slidingly arranged on the fixed disc, and a bottom of the guide column is connected to the bottom of an equipment box; a top of the guide column passes through the fixed disc and is connected to a limit block.

In some embodiments, the lifting structure includes a rectangular lifting platform, a center of the lifting platform is provided with a circular hole, and the transparent placement platform is arranged in the circular hole and connected to the circular hole in a manner of rotation, a bearing block is arranged in the circular hole, and the transparent placement platform is arranged on the bearing block and slidingly connected to the bearing block;

a set of diagonals of the lifting platform is symmetrically arranged with a screw; a top of the screw is connected to the top of the transparent display box in a manner of rotation through a rotating seat; the top of the screw is to the bottom of the equipment box in a manner of rotation through the rotating seat, the screw passes through the lifting platform and is in a threaded connection with the lifting platform, a first gear is sleeved on the screw.

In some embodiments, the switching structure includes a servo motor arranged between the screw and the gear disc, an output shaft of the servo motor is provided with a second gear that is compatible with the first gear and the gear disc, a bottom of the servo motor is provided with a moving seat, a bottom of the moving seat is connected to a top of a fixed seat through an inclined plane, and the fixed seat is fixed at the bottom of the equipment box, the bottom of the equipment box is provided with a first electric hydraulic cylinder, a bottom of the first electric hydraulic cylinder is hinged to the equipment box, and a telescopic rod of the first electric hydraulic cylinder is hinged to a side of a moving seat.

In some embodiments, the display cabinet is provided with a lifting frame, a bottom of the lifting frame is connected to the telescopic rod of a second electric hydraulic cylinder, the second electric hydraulic cylinder is arranged in an interior of the display cabinet, a bottom of the touch display screen is connected to the top of the lifting frame in a manner of rotation, a fixed plate is arranged on a side of the lifting frame away from the bottom of the touch display screen, and a third electric hydraulic cylinder is arranged on the fixed plate, a bottom of the third electric hydraulic cylinder is hinged with the fixed plate, and the telescopic rod of the electric hydraulic cylinder is hinged with a rear of the touch display screen.

In some embodiments, the three-dimensional graphics acquisition sensing component includes a binocular camera, a laser scanner, and a high-definition camera for collecting product models made by intangible cultural heritage techniques.

The present disclosure further provides a digital display method for intangible cultural heritage products, including the following steps:

S1, placing a product model made by the intangible cultural heritage techniques on the transparent placement platform, driving the gear disc to rotate by the servo motor, thereby driving the transparent placement platform to rotate; collecting three-dimensional information of the product model by the three-dimensional graphics acquisition sensing components located above, side, and below the transparent placement platform, and transmitting the three-dimensional information to the upper computer through wireless transmission;

S2, processing the transmitted three-dimensional information by the upper computer, establishing a three-dimensional model, and transmitting the three-dimensional model to the touch display screen;

S3, sliding the servo motor on the fixed seat through the moving seat, the servo motor may move upwards to close to the screw, monitoring the servo motor through the high-definition camera of the three-dimensional graphics acquisition sensing component below the transparent placement platform, and transmitting a monitoring image to the upper computer in real time, controlling the servo motor to make the second gear of the servo motor mesh with the first gear on the screw by the upper computer, driving the screw to rotate by the servo motor, thereby raising the lifting platform, elevating the transparent placement platform to adjust an exhibition height of the product model;

S4, adjusting a height of the touch display screen by lifting the lifting frame, and adjusting a pitch angle of the touch display screen by rotating the touch display screen on the lifting frame; and

S5, completing the adjustment of the product model and the touch display screen, thereby displaying the three-dimensional model along with the corresponding pre-recorded intangible cultural heritage techniques display video on the touch display screen by the upper computer.

Therefore, the present disclosure adopts the above-mentioned digital display device and method for intangible cultural heritage products, and has the following beneficial effects:

1, The present disclosure utilizes a rotating transparent placement platform for holding product models of intangible cultural heritage techniques, coordinated with three-dimensional graphic acquisition sensing components on its sides, combined with additional three-dimensional graphic acquisition sensing components above and below, to collect three-dimensional information of the product model on the transparent placement platform. This achieves three-dimensional modeling without moving the product model;

2, The present disclosure collects and transmits the three-dimensional information of the product model made by the intangible cultural heritage techniques on the transparent placement platform to the upper computer, and the upper computer generates three-dimensional graphics to display on the touch display screen of the display cabinet, which is convenient for people to observe the three-dimensional model made by the intangible cultural heritage techniques and cooperate with the video explanation and display of the intangible cultural heritage techniques, so that people can have a full range of understanding and awareness of the intangible cultural heritage products;

3, The present disclosure promotes the moving seat through the electric hydraulic cylinder, cooperates with the fixed seat connected to the inclined plane of the moving seat, pushes the moving seat up, completes the movement of the servo motor on the moving seat, and cooperates with the high-definition camera monitoring of the three-dimensional graphics acquisition sensing component to realize the servo motor driving the rotation of the transparent placement platform to switch and drive the screw rotation, to realize the lifting of the lifting platform and adjust the height of the product model on the transparent placement platform, which is more convenient.

The technical scheme of the present disclosure is further described in detail through the figures and examples.

### BRIEF DESCRIPTION OF THE DRAWINGS

FIG. 1 is a schematic diagram of the overall structure of the example of the digital display device of an intangible cultural heritage product of the present disclosure;

FIG. 2 is a schematic diagram of the structure of the lifting and rotating switching component of the example of the present disclosure;

FIG. 3 is a schematic diagram of the lifting frame structure of the example of the present disclosure.

### Marks in the figures

1, exhibition cabinet; 2, display cabinet; 3, transparent display box; 4. equipment box; 5, fixed disc; 6, bearing; 7, gear disc; 8, transmission tooth; 9, three-dimensional graphics acquisition sensing component; 10, fixed column; 11, transparent placement platform; 12, guide column; 13, limit block; 14, lifting platform; 15, bearing block; 16, screw;17, first gear; 18, servo motor; 19, second gear; 20, moving seat; 21, fixed seat; 22, first electric hydraulic cylinder; 23, rotating seat; 24, lifting frame; 25, second electric hydraulic cylinder; 26, fixed plate; 27, third electric hydraulic cylinder; 28, touch display screen.

### DETAILED DESCRIPTION OF THE EMBODIMENTS

For clearly and completely disclosing the objectives, technical solutions, and advantages of the examples of the present disclosure, the following further elaborates on the examples with reference to the accompanying figures and examples. It should be understood that the specific examples described here are only used to explain the examples of the present disclosure, and are not used to limit the examples of the present disclosure. Based on the examples in this application, all other examples obtained by ordinary technical personnel in this field without making creative work belong to the scope of protection in this application. Examples of the embodiments are shown in the accompanying figures, wherein the same or similar labels from beginning to end represent the same or similar components or components with the same or similar functions.

It should be noted that the terms “include” and “have” and any deformation of them are intended to cover non-exclusive inclusion, for example, a process, a method, a system, a product or a server that contains a series of steps or units need not be limited to those steps or units that are clearly listed, but may include other steps or units that are not clearly listed or are inherent to those processes, methods, products or equipment.

Similar labels and letters represent similar items in the following figures. Therefore, once an item is defined in a figure, it does not need to be further defined and explained in the subsequent figure.

In the description of the present disclosure, it is necessary to explain that the orientation or positional relationship indicated by the terms “up”, “down”, “inside”, “outside”, etc. is based on the orientation or positional relationship shown in the attached figure, or is the orientation or positional relationship that is habitually placed when the invention product is used, only to facilitate the description of the present disclosure and simplify the description, rather than to indicate or imply that the device or component referred to must have a specific orientation, be constructed and operated in a specific orientation, and therefore cannot be understood as a limitation to the present disclosure.

In the description of the present disclosure, it is further necessary to explain that, unless otherwise clearly defined and limited, the terms “set”, “install”, “connect” should be understood in a broad sense, for example, it can be fixed connection, detachable connection, or integrated connection; it can be mechanical connection or electrical connection; it can be directly connected or indirectly connected through an intermediate medium, which can be the internal connection of two components. For ordinary technicians in this field, the specific meaning of the above terms in this present disclosure can be understood in detail.

### Example

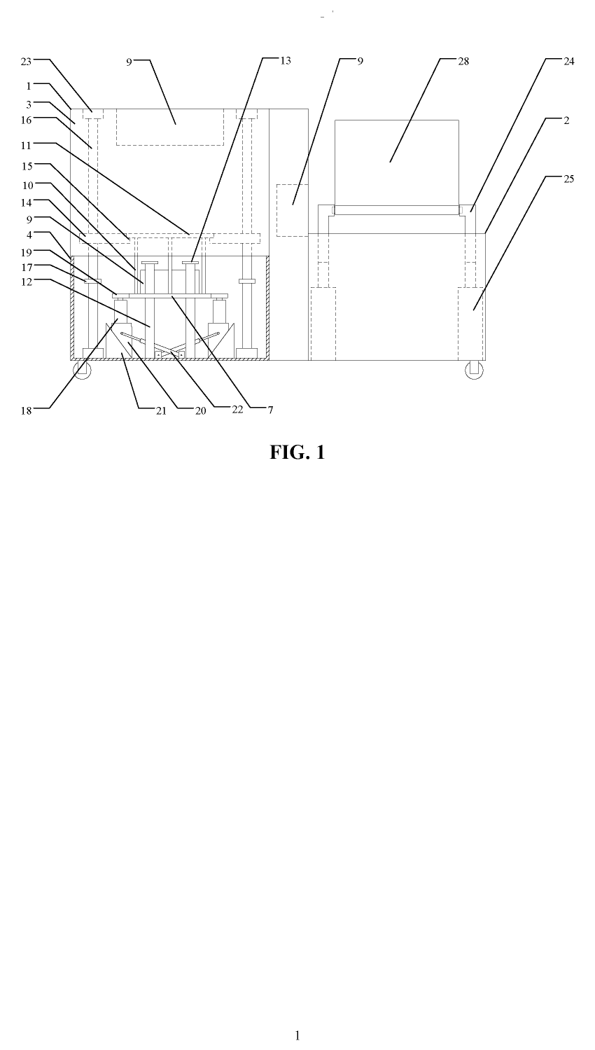

As shown in FIG. 1, a digital display device for intangible cultural heritage products described in the present disclosure includes an exhibition cabinet 1 with a transparent glass display function and a display cabinet 2 with a touch display function. The side of the exhibition cabinet 1 is connected to the side of the display cabinet 2, the exhibition cabinet 1 and the display cabinet 2 are connected as an integrated structure, and the bottom four corners are equipped with moving wheels to drive the whole display device to move.

Exhibition cabinet 1 includes transparent display box 3 in the upper part and non-transparent equipment box 4 in the lower part. Transparent display box 3 is provided with a transparent placement platform 11 for placing product models made of intangible cultural heritage techniques. The transparent placement platform 11 is connected to the equipment box 4 through the lifting and rotating switching component. The top, bottom, and side of the transparent placement platform 11 are all provided with a three-dimensional graphics acquisition sensing component 9 for collecting three-dimensional information. The side of the transparent display box 3 away from the display cabinet 2 is provided with a transparent glass with an opening and closing function. The top of the transparent display box 3, the front and rear sides of the vertical connection with the side away from the display cabinet 2 are provided with transparent glass. Its opening and closing function can be realized by adding the existing hinges and locks, which are the same as the existing open-close glass door structure.

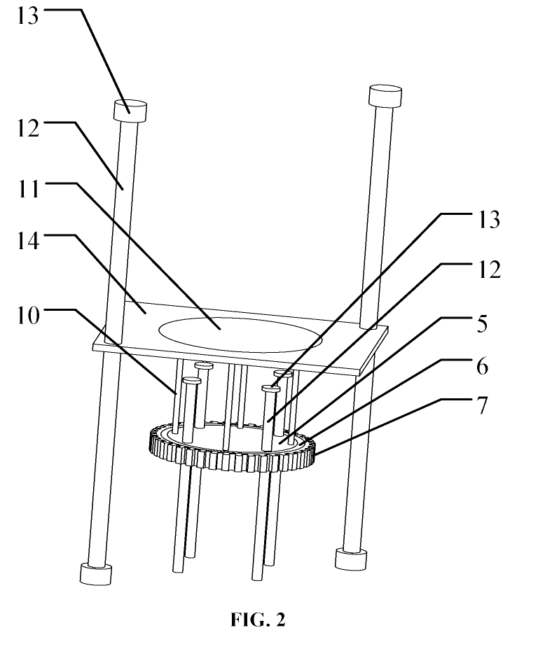

As shown in FIG. 2, the lifting and rotating switching component includes a composite drive disc. The lifting structure is arranged on both sides of the composite drive disc, and a switching structure is arranged between the composite drive disc and the lifting structure. The composite drive disc includes a fixed disc 5 arranged in the center. The side of the fixed disc 5 is connected to the gear disc 7 through bearing 6. The outer side of the gear disc 7 is provided with several transmission teeth 8. The three-dimensional graphics acquisition sensing component 9 under the transparent placement platform 11 is arranged on the fixed disc 5. The top of the gear disc 7 is connected to the bottom of the transparent platform 11 through a fixed column 10. The fixed disc 5 is provided with several guide columns 12. The bottom of the guide column 12 is connected to the bottom of the equipment box 4. The top of the guide column 12 passes through the fixed disc 5, thereby connecting to the limit block 13.

The lifting structure includes a rectangular lifting platform 14, the center of the lifting platform 14 is provided with a circular hole, the transparent placement platform 11 is arranged in the circular hole, and connected to the circular hole in a manner of rotation. The bearing block 15 is arranged in the circular hole, and the transparent placing platform 11 is arranged on the bearing block 15 and slidingly connected with the bearing block 15. The set of diagonals of the lifting platform 14 is symmetrically arranged with the screw 16. The top of the screw 16 is connected to the top of the transparent display box 3 in a manner of rotation through the seat 23. The top of the screw 16 is connected to the bottom of the equipment box 4 in a manner of rotation through the seat 23. The screw 16 passes through the lifting platform 14 and is in a threaded connection with the lifting platform 14. The first gear 17 is sleeved on the screw 16.

The switching structure includes a servo motor 18 that is arranged between the screw 16 and the gear disc 7, and the output shaft of the servo motor 18 is provided with the second gear 19 that is compatible with the first gear 17 and the gear disc 7. The bottom end of the servo motor 18 is provided with a moving seat 20. The bottom end of the moving seat 20 is connected to the top end of the fixed seat 21 through an inclined plane, and the fixed seat 21 is fixed at the bottom of the equipment box 4. The first electric hydraulic cylinder 22 is arranged at the bottom of the equipment box 4. The bottom of the first electric hydraulic cylinder 22 is hinged to the equipment box 4. The telescopic rod of the first electric hydraulic cylinder 22 is hinged to the side of the moving seat 20.

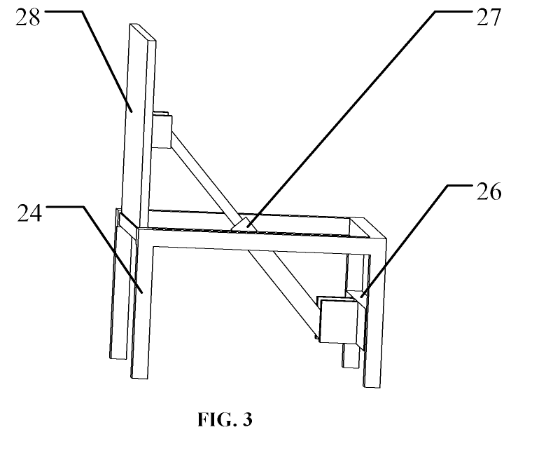

There is a touch display screen 28 with height adjustment and pitch angle adjustment functions on the display cabinet 2. As shown in FIG. 3, the display cabinet 2 is provided with a lifting frame 24. The bottom of the lifting frame 24 is connected to the telescopic rod of the second electric hydraulic cylinder 25, and the second electric hydraulic cylinder 25 is arranged inside the display cabinet 2. The bottom of the touch display screen 28 is connected to the side of the top of the lifting frame 24 in a manner of rotation. The side of the lifting frame 24 away from the bottom of the touch display screen 28 is provided with a fixed plate 26, and the fixed plate 26 is provided with an electric hydraulic cylinder 327. The bottom of the third electric hydraulic cylinder 27 is hinged with the fixed plate 26, and the telescopic rod of the electric hydraulic cylinder is hinged with the rear of the touch display screen 28.

Three-dimensional graphics acquisition sensing component 9 includes a binocular camera, a laser scanner, a high-definition camera, and so on, which are used to collect product models made by intangible cultural heritage techniques.

A digital display method of intangible cultural heritage products described in the present disclosure includes the following steps:

S1, the transparent glass with the opening and closing function is opened, and the product model crafted using intangible cultural heritage techniques is placed on the transparent placement platform 11. The transparent glass is then closed. The upper computer controls the servo motor 18 to start. The output shaft of the servo motor 18 drives the second gear 19 to rotate, which at this time engages with the gear disc 7 and drives it to rotate. The gear disc 7, in turn, drives the transparent placement platform 11 to rotate on the lifting platform 14 via the fixed column 10 (while the gear disc 7 rotates, the fixed disc 5 remains stationary due to the action of bearing 6). Meanwhile, the three-dimensional graphics acquisition sensing component 9, located on the top, side, and bottom of the transparent placement platform 11, collects the three-dimensional information of the product model on the platform and transmits it to the upper computer via wireless transmission.

S2, the upper computer processes the transmitted three-dimensional information and establishes a three-dimensional model, and transmits the three-dimensional model to the touch display screen 28.

S3, the upper computer controls the servo motor 18 to stop. The telescopic rod of the first electric hydraulic cylinder 22 elongates and pushes the moving seat 20 upward along the inclined plane between the moving seat 20 and the fixed seat 21, the servo motor 18 on the moving seat 20 then moves up close to the screw 16. During this approaching process, the high-definition camera of the three-dimensional graphics acquisition sensing component 9 under the transparent placement platform 11 monitors the servo motor 18 and transmits the monitoring image to the upper computer in real time, the upper computer then drives the second gear 19 to rotate by controlling the servo motor 18, thereby engaging the second gear 19 of the servo motor 18 with the first gear 17 on the screw 16, the servo motor 18 drives the screw 16 to rotate through the second gear 19 and the first gear 17, which raises the lift platform 14, the bearing block 15 on the lifting platform 14 subsequently drives the transparent placement platform 11 to rise, thereby adjusting the exhibition height of the product model. (When the lifting platform 14 drives the transparent placing platform 11 to rise, the fixed plate 5 slides on the guide column 12, and the limit block 13 at the top of the guide column 12 prevents the fixing plate 5 from separating from the guide column 12. When the lifting platform 14 falls, the transparent placing platform 11 follows the lifting platform 14 downward under gravity.)

S4, the telescopic rod of the second electric hydraulic cylinder 25 drives the lifting frame 24 to lift, this action adjusts the height of the touch display screen 28, then, the telescopic rod of the third electric hydraulic cylinder 27 drives the touch display screen 28 to flip up or down, thereby adjusting its pitch angle. (When not in use, the third electric hydraulic cylinder 27 drives the touch display screen 28 to flip down into the lifting frame 24.); and

S5, after the adjustment of the product model and the touch display screen 28 is complete, the upper computer displays the three-dimensional model along with the corresponding pre-recorded intangible cultural heritage techniques display video on the touch display screen 28.

Finally, it should be noted that the above examples are only used to explain the technical scheme of the present disclosure rather than to restrict it. Although the present disclosure is described in detail with reference to the better examples, ordinary technicians in this field should understand that they can still modify or replace the technical scheme of the present disclosure, and these modifications or equivalent replacements cannot make the modified technical scheme out of the spirit and scope of the technical scheme of the present disclosure.

What is claimed is:

1. A digital display device for intangible cultural heritage products, comprising an exhibition cabinet with a transparent glass display function and a display cabinet with a touch display function, wherein:
a side of the exhibition cabinet is connected to a side of the display cabinet, the exhibition cabinet comprises a transparent display box in the upper part and a non-transparent equipment box in the lower part, the transparent display box is provided with a transparent placement platform for placing product models made of intangible cultural heritage techniques, the transparent placement platform is connected to the equipment box through a lifting and rotating switching component, the top, bottom, and side of the transparent placement platform are provided with three-dimensional graphics acquisition and sensing components for collecting three-dimensional information, and the display cabinet is provided with a touch display screen with height adjustment and pitch angle adjustment functions.

2. The digital display device for intangible cultural heritage products according to claim 1, wherein a side of the transparent display box away from the display cabinet is provided with transparent glass comprising an opening and closing function, and wherein a top of the transparent display box, a front side, and a rear side of one side of the transparent display box vertically connected to the side away from the display cabinet are provided with transparent glass.

3. The digital display device for intangible cultural heritage products according to claim 1, wherein the lifting and rotating switching component comprises a composite drive disc, and the lifting structure is arranged on both sides of the composite drive disc, and the switching structure is arranged between the composite drive disc and a lifting structure.

4. The digital display device for intangible cultural heritage products according to claim 3, wherein the composite drive disc comprises a fixed disc arranged in the center, and wherein the side of the fixed disc is connected to a gear disc through a bearing, the outer side of the gear disc is provided with several transmission teeth, and the three-dimensional graphics acquisition and sensing components under the transparent placement platform are arranged on the fixed disc.

5. The digital display device for intangible cultural heritage products according to claim 4, wherein the top of the gear disc is connected to the bottom of the transparent placement platform through several fixed columns, and there are several guide columns on the fixed plate, and wherein the bottom of the guide column is connected to the bottom of the equipment box, and the top of the guide column is connected to a limit block after passing through the fixed plate.

6. The digital display device for intangible cultural heritage products according to claim 5, wherein the lifting structure comprises a rectangular lifting platform, the center of the lifting platform is arranged with a circular hole, the transparent placement platform is arranged in the circular hole and connected to the circular hole in a manner of rotation, the circular hole is provided with a bearing block, and the transparent placement platform is arranged on the bearing block and slidingly connected with the bearing block;
wherein a set of diagonals of the lifting platform is symmetrically arranged with a screw, the top of the screw is connected to the top of the transparent display box in a manner of rotation through the rotating seat, the top of the screw is connected to the bottom of the equipment box in a manner of rotation through the rotating seat, the screw passes through the lifting platform and is in a threaded connection with the lifting platform, and a first gear is sleeved on the screw.

7. The digital display device for intangible cultural heritage products according to claim 6, wherein the switching structure comprises a servo motor, which is arranged between the screw and the gear disc, the output shaft of the servo motor is provided with a second gear that is compatible with the first gear and the gear disc, the bottom of the servo motor is provided with a moving seat, the bottom of the moving seat is connected to the top of the fixed seat through an inclined plane, and the fixed seat is fixed at the bottom of the equipment box, the bottom of the equipment box is provided with a first electric hydraulic cylinder, the bottom of the first electric hydraulic cylinder is hinged with the equipment box, and a telescopic rod of the first electric hydraulic cylinder is hinged with the side of the moving seat.

8. The digital display device for intangible cultural heritage products according to claim 1, wherein the display cabinet is provided with a lifting frame, the bottom of the lifting frame is connected to a telescopic rod of a second electric hydraulic cylinder, the second electric hydraulic cylinder is arranged in the interior of the display cabinet, the bottom of the touch display screen is connected to the top of the lifting frame in a rotating manner, a fixed plate is arranged on the side of the lifting frame away from the bottom of the touch display screen, and a third electric hydraulic cylinder is arranged on the fixed plate, wherein the bottom of the third electric hydraulic cylinder is hinged with the fixed plate, and the telescopic rod of the electric hydraulic cylinder is hinged with the rear of the touch display screen.

9. The digital display device for intangible cultural heritage products according to claim 1, wherein the three-dimensional graphics acquisition sensing component includes a binocular camera, a laser scanner, and a high-definition camera for collecting product models made by intangible cultural heritage techniques.

10. A digital display method for intangible cultural heritage products, wherein the digital display device for intangible cultural heritage products according to claim 1 is utilized according to the following steps:
S1, placing a product model made by the intangible cultural heritage techniques on the transparent placement platform, driving the gear disc to rotate by the servo motor, thereby driving the transparent placement platform to rotate, collecting the three-dimensional information of the product model by three-dimensional graphics acquisition sensing components positioned above, to the side, and below the transparent placement platform, and transmitting the three-dimensional information to the upper computer through wireless transmission;
S2, processing the transmitted three-dimensional information by the upper computer, establishing a three-dimensional model, and transmitting the three-dimensional model to the touch display screen;
S3, sliding the servo motor on the fixed seat through the moving seat, wherein the servo motor may move upwards to close to the screw, and monitoring the servo motor through the high-definition camera of the three-dimensional graphics acquisition sensing component below the transparent placement platform, transmitting the monitoring image to the upper computer in real time, controlling the servo motor to make the second gear of the servo motor mesh with the first gear on the screw by the upper computer, driving the screw to rotate by the servo motor, thereby raising the lifting platform, and elevating the transparent placement platform to adjust the exhibition height of the product model;
S4, adjusting the height of the touch display screen by lifting the lifting frame, and adjusting the pitch angle of the touch display screen by rotating the touch display screen on the lifting frame; and
S5, completing the adjustment of the product model and the touch display screen, thereby displaying the three-dimensional model along with the corresponding pre-recorded intangible cultural heritage techniques display video on the touch display screen by the upper computer.
